(19) United States
(12) Patent Application Publication
(10) Pub. No.: US 2011/0213998 A1
(43) Pub. Date: Sep. 1, 2011

(54) System and Method for Power Optimization

(76) Inventors: John George Mathieson, San Jose, CA (US); Phil Carmack, Santa Clara, CA (US); Brian Smith, Mountain View, CA (US)

(21) Appl. No.: 12/787,361

(22) Filed: May 25, 2010

Related U.S. Application Data
(63) Continuation-in-part of application No. 12/137,053, filed on Jun. 11, 2008.

(51) Int. Cl. G06F 1/32; G06F 15/76

(52) U.S. Cl. 713/324; 712/16; 712/E09.001

(57) ABSTRACT

A technique for reducing the power consumption required to execute processing operations. A processing complex, such as a CPU or a GPU, includes a first set of cores comprising one or more fast cores and second set of cores comprising one or more slow cores. A processing mode of the processing complex can switch between a first mode of operation and a second mode of operation based on one or more of the workload characteristics, performance characteristics of the first and second sets of cores, power characteristics of the first and second sets of cores, and operating conditions of the processing complex. A controller causes the processing operations to be executed by either the first set of cores or the second set of cores to achieve the lowest total power consumption.

### CROSS-REFERENCE TO RELATED APPLICATIONS

This application in a continuation-in-part of U.S. patent application Ser. No. 12/137,053, filed on Jun. 11, 2008 (Attorney Docket No. NVDA/P003709), which is hereby incorporated herein by reference.

### BACKGROUND OF THE INVENTION

1. Field of the Invention

The present invention relates generally to computer hardware and, more specifically, to a system and method for power optimization.

2. Description of the Related Art

Low power design has become increasingly important in recent years. With the proliferation of battery-powered mobile devices, efficient power management is quite important to the success of a product or system.

A number of techniques have been developed to increase performance and/or reduce power consumption in conventional integrated circuits (ICs). For example, sleep and standby modes, multi-threading techniques, multi-core techniques, and other techniques are currently implemented to increase performance and/or decrease power consumption. However, these techniques do not reduce power consumption enough to meet the requirements of certain emerging technologies and products.

As the foregoing illustrates, what is needed in the art is an improved technique for power optimization that overcomes the drawbacks associated with conventional approaches.

### SUMMARY

One embodiment of the invention sets forth a computer-implemented method for processing one or more operations within a processing complex. The method includes causing the one or more operations to be processed by a first set of cores within the processing complex; evaluating at least a workload associated with processing the one or more operations to determine that the one or more operations should be processed by a second set of cores included within the processing complex; and causing the one or more operations to be processed by the second set of cores.

Another embodiment of the invention provides a computer-implemented method for processing one or more operations within a processing complex. The method includes causing the one or more operations to be processed by a first set of cores within the processing complex; evaluating at least a workload associated with processing the one or more operations, performance data and power data associated with the first set of cores, and performance data and power data associated with a second set of cores included within the processing complex to determine whether the one or more operations should continue to be processed by the first set of cores or should be processed by the second set of cores; and causing the one or more operations to continue to be processed by the first set of cores or to be processed by the second set of cores.

Yet another embodiment of the invention provides a computer-implemented method for processing one or more operations within a processing complex. The method includes causing the one or more operations to be processed by a first set of cores included within the processing complex, where the first set of core is configured to utilize a resource unit when processing the one or more operations; evaluating at least a workload associated with processing the one or more operations to determine that the one or more operations should be processed by a second set of cores included within the processing complex; and causing the one or more operations to be processed by the second set of cores included within the processing complex, where the second set of cores is configured to utilize the resource unit when processing the one or more operations.

Advantageously, embodiments of the invention provide techniques to decrease the total power consumption of a processor.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the invention.

FIG. 2 is a conceptual diagram illustrating a processing complex that includes heterogeneous cores, according to one embodiment of the invention.

FIG. 3 is a conceptual diagram illustrating a processing complex that includes a shared resource, according to one embodiment of the invention.

FIGS. 4A-4B are flow diagrams of method steps for switching between modes of operation of a processing complex, according to various embodiments of the invention.

FIG. 5 is a flow diagram of method steps for switching between modes of operation of a processing complex having a shared resource, according to one embodiment of the invention.

FIG. 6 is a conceptual diagram illustrating power consumption as a function of operating frequency for different types of processing cores, according to one embodiment of the invention.

### DETAILED DESCRIPTION

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring embodiments of the invention.

### System Overview

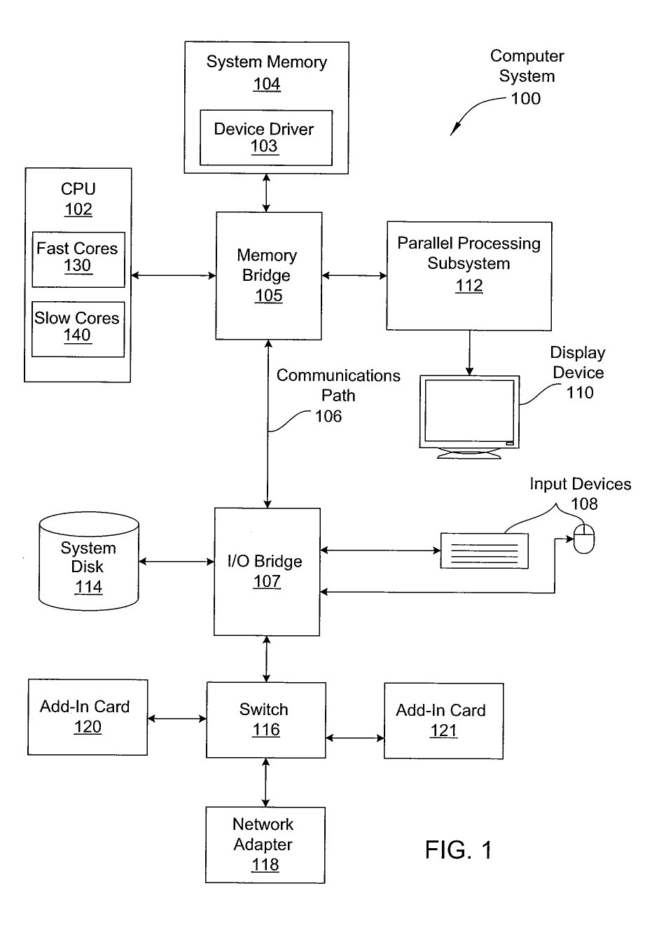

FIG. 1 is a block diagram illustrating a computer system 100 configured to implement one or more aspects of the invention. Computer system 100 includes a central processing unit (CPU) 102 and a system memory 104 communicating via a bus path through a memory bridge 105. The CPU 102 includes one or more “fast” cores 130 and one or more “shadow” or slow cores 140, as described in greater detail herein. In some embodiments, the cores 130 are associated with higher performance and higher leakage power than the cores 140. Memory bridge 105 may be integrated into CPU 102 as shown in FIG. 1. Alternatively, memory bridge 105, may be a conventional device, e.g., a Northbridge chip, that is coupled to CPU 102 via a bus. Memory bridge 105 is also coupled to an I/O (input/output) bridge 107 via communication path 106 (e.g., a HyperTransport link).

I/O bridge 107, which may be, e.g., a Southbridge chip, receives user input from one or more user input devices 108 (e.g., keyboard, mouse) and forwards the input to CPU 102 via path 106 and memory bridge 105. A parallel processing subsystem 112 is coupled to memory bridge 105 via a bus or other communication path 113 (e.g., a PCI Express, Accelerated Graphics Port, or HyperTransport link); in one embodiment parallel processing subsystem 112 is a graphics subsystem that delivers pixels to a display device 110 (e.g., a conventional CRT or LCD based monitor). A system disk 114 is also connected to I/O bridge 107. A switch 116 provides connections between I/O bridge 107 and other components such as a network adapter 118 and various add-in cards 120 and 121. Other components (not explicitly shown), including USB or other port connections, CD drives, DVD drives, film recording devices, and the like, may also be connected to I/O bridge 107. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture. In yet another embodiment, the parallel processing subsystem 112 may be integrated with one or more other system elements, such as the memory bridge 105, CPU 102, and I/O bridge 107 to form a system on chip (SoC).

It will be appreciated that the system shown in FIG. 1 is illustrative and that variations and modifications are possible. The connection topology, including the number and arrangement of bridges, may be modified as desired. For instance, in some embodiments, system memory 104 is directly connected to CPU 102 rather than connected through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, one or more of CPU 102, I/O bridge 107, parallel processing subsystem 112, and memory bridge 105 may be integrated into one or more chips. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

### Power Optimization Implementation

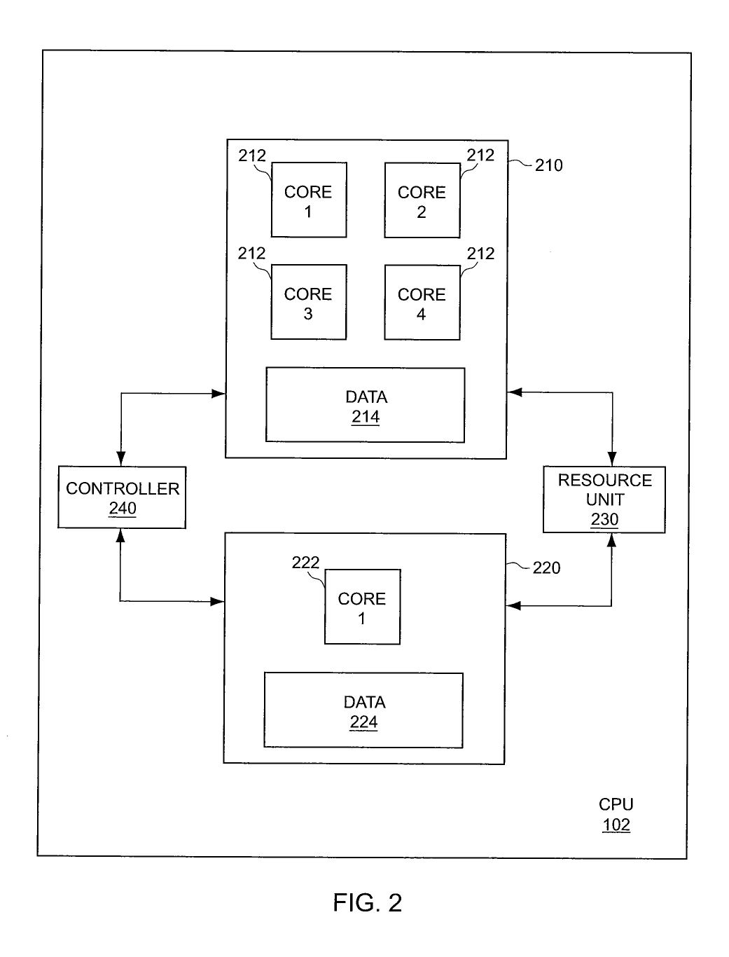

FIG. 2 is a conceptual diagram illustrating a processing complex that includes heterogeneous cores, according to one embodiment of the invention. As shown, the processing complex comprises the CPU 102 shown in FIG. 1. In other embodiments, the processing complex may be any other type of processing unit, such as a graphics processing unit (GPU).

The CPU 102 includes a first set of cores 210, a second set of cores 220, a shared resource 230, and a controller 240. Other components included within the CPU 102 are omitted to avoid obscuring embodiments of the invention. In some embodiments, the first set of cores 210 includes one or more cores 212 and data 214, and the second set of cores 220 includes one or more cores 222 and data 224. In some embodiments, the first set of cores 210 and the second set of cores 220 are included on the same chip. In other embodiments, the first set of cores 210 and the second set of cores 220 are included on separate chips that comprise the CPU 102.

As shown, the CPU 102, also referred to herein as the “processing complex,” includes the first set of cores 210 and the second set of cores 220. In one embodiment, the cores included in the first set of cores 210 may implement substantially the same functionality as the cores included in the second set of cores 220. In alternative embodiments, each given set of cores 210, 220 may implement a particular functional block of the CPU 102, such as an arithmetic and logic unit, a fetch unit, a graphics pipeline, a rasterizer, or the like. In still further embodiments, the cores included in the second set of cores 220 may be capable of a subset of the functionality of the cores included in the first set of cores 210. Various designs are within the scope of embodiments of the invention and may be based on trade-offs in usage for providing the shared functionality.

According to various embodiments, the power consumption associated with the CPU 102 is derived from “dynamic” switching power and “static” leakage power. The switching power loss is based on the charging and discharging of the each transistor and its associated capacitance, and increases with operating frequency and number of gates. The leakage power loss is based on gate and channel leakage in each transistor, and increases as process geometry decreases.

According to various embodiments, the cores 212 included in the first set of cores 210 comprise “fast” cores and the cores 222 included in the second set of cores 220 comprise “slow” cores. For example, the cores 212 may be manufactured using faster transistors that have significant static leakage. In some embodiments, when the computing needs and/or workload of the first set of cores 210 are lowered, then the clock speed is lowered to reduce power. The static leakage is not a significant issue at the high clock speeds required for peak performance. However, at slower clock speeds, the static leakage of the fast transistors can dominate the overall power consumption. According to various embodiments, the first set of cores includes N cores and the second set of cores includes M cores. In one embodiment, N is not equal to M. In other embodiments, N is equal to M. In some embodiments, the first set of cores 210 may include multiple cores, e.g., four cores, and the second set of cores 220 may include a single core 222. In other embodiments, the first set of cores 210 may include a single core and/or the second set of cores 220 may include multiple cores.

Thus, according to various embodiments, the second set of cores 220, also referred to as “shadow” cores, are also included within the CPU 102. The second set of cores 220 includes one or more “slow” cores 222 constructed from slower transistors that are not capable of operating as quickly as the transistors includes in the cores 212 of the first set of cores 210. In some embodiments, the second set of cores 220 has a much lower leakage power loss that the first set of cores 210, but is not capable of achieving the same performance levels as the first set of cores 210.

In some embodiments, a controller 240 included within the CPU 102 is configured to evaluate at least a workload associated with one or more operations to be executed by the CPU 102. In some embodiments, the controller is implemented in software and is executed by the CPU 102. Based on the evaluated workload, the controller 240 is able to configure the CPU 102 to operate in a first mode of operation or a second mode of operation. In the first mode of operation, the first set of cores 210 is enabled and operable and the second set of cores 220 is disabled. In the second mode of operation, the second set of cores 220 is enabled and operable and the first set of cores 210 is disabled. In addition, in various embodiments, the controller 240 is able to increase and/or decrease the operating frequency of the first processor and/or the second processor when operating the CPU 102 in each of the first and second modes. In one embodiment, the first set of cores 210 is disabled and powered off when the one or more operations are processed by the second set of cores 220. In alternative embodiments, the first set of cores 210 is clock gated and/or power gated when the one or more operations are processed by the second set of cores 220.

For example, if the CPU 102 is operating in the first mode at high frequency, and the controller 240 detects that the workload has decreased to a point where operating in the first mode at lower frequency would save power, then the controller 240 may decrease the operating frequency of the first set of cores 210. If the controller 240 later detects that the workload has further decreased to a point where the CPU 102 would use less power to operate in the second mode, then the controller 240 causes the CPU 102 to operate in the second mode. In some embodiments, the CPU 102 may operate in both the first mode and the second mode simultaneously. In some embodiments, operating in both the first and second modes simultaneously may result in lower overall power efficiency. For example, the CPU 102 may operate in both the first mode and the second mode simultaneously during a transition period when transitioning between the first mode and second mode, or vice versa.

In one embodiment, evaluating the workload includes determining whether a processing parameter associated with processing the one or more operations is greater than or less than a threshold value. For example, the processing parameter may be a processing frequency, and the evaluating at least the workload comprises determining that the one or more operations should be processed at a processing frequency that is greater than or less than a threshold frequency. In another example, the processing parameter may be instruction throughput, and the evaluating at least the workload comprises determining that the instruction throughput when processing the workload should be greater than or less than a threshold throughput.

In some embodiments, determining that processing operations should switch from being executed by the first set of cores 210 to being executed by the second set of cores 220, and vice versa, is based on evaluating at least the workload, as described above, and performance data and/or power data associated with the first and/or second sets of cores. As also shown in FIG. 2, each of the first and second sets of cores 210 and 220 includes data 214 and 224, respectively.

According to various embodiments, the data 214, 224 includes performance data and/or power data. The performance data associated with the first set of cores and the second set of cores includes at least one of an operating frequency range of the first set of cores and an operating frequency range of the second set of cores, the number of cores in the first set of cores and the number of cores in the second set of cores, and an amount of parallelism between the cores in the first set of cores and an amount of parallelism between the cores in the second set of cores. The power data associated with the first set of cores and the second set of cores includes at least one of a maximum voltage at which the cores in the first set of cores can operate and a maximum voltage at which the cores in the second set of cores can operate, a maximum current that the cores in the first set of cores can tolerate and a maximum current that the cores in the second set of cores can tolerate, and an amount of power dissipation as a function of at least an operating frequency for the cores in the first set of cores and an amount of power dissipation as a function of at least an operating frequency for the cores in the second set of cores.

According to various embodiments, the controller 240 is configured to evaluate the data 214, 224 and determine which set of cores should execute the processing operations based, at least in part, on the data 214. In one embodiment, the data 214, 224 is included within fuses associated with the processing complex and the controller 240 is configured to read the data 214, 224 from the fuses. In alternative embodiments, the data 214, 224 is determined dynamically during operation of the processing complex by the controller 240.

In one embodiment, the particular silicon composition, process technology, and/or logical implementations used to manufacture each of the first and second processors 210, 220 is known at the time of manufacture. In some embodiments, the silicon composition and/or process technology associated with the first processor 210 is different than the silicon composition and/or process technology associated with the second processor 220. However, each integrated circuit manufactured is not identical. Minor variations exist between ICs, even ICs on the same wafer. Therefore, the characteristics associated with an IC may vary from chip-to-chip. According to various embodiments of the invention, at the time of manufacturing, each chip may be measured with a testing device to measure the performance data and/or the power data associated with the first set of cores 210 and the performance data and/or the power data associated with the second set of cores 220. The dynamic power, in some embodiments, is approximately equal between chips and can be estimated as a function of the number of gates and operating frequency. In other embodiments, the silicon composition and/or process technology could be mixed between chips and/or cores, thereby providing different dynamic power between chips and/or cores.

Based on the measured and/or estimated characteristics, one or more fuses may be set on the CPU 102 to characterize the performance data and/or the power data of the CPU 102 based on various characteristics, such as operating frequency, voltage, temperature, throughput, and the like. In some embodiments, the one or more fuses may comprise the data 214 and 224 shown in FIG. 2. Accordingly, the controller 240 may be configured to read the data 214, 224 and determine which mode of operation is most optimal based on the particular operating characteristics at a particular time.

In some embodiments, the data 214, 224 changes dynamically during operation of the first and/or second sets of cores 210, 220. For example, temperature changes associated with the CPU 102 may causes one or more of the performance data 214, 224 to change. Accordingly, the controller 240 may determine that a certain mode of operation is more power efficient, based on the dynamic operating temperature information. In some embodiments, the controller 240 may determine the current operating characteristics and perform a table look-up to determine which mode of operation is most power efficient. The table may be organized based on ranges of the different operating characteristics of the CPU 102. In alternative embodiments, the controller 240 may determine which mode of operation is more power efficient based on evaluating a function having inputs associated with the different operating characteristics. For example, the function may be a discrete or continuous function.

In some embodiments, determining which set of cores should execute the processing operations is based on evaluating one or more operating conditions of the processing complex. The one or more operating conditions may include at least one of a supply voltage, a temperature of each chip included in the processing complex, and an average leakage current over a period of time of each chip included in the processing complex. The one or more operating conditions may be determined dynamically during operation of the processing complex.

In some embodiments, determining whether the one or more operations should continue to be processed by the first set of cores or should be processed by the second set of cores is based on at least one of the thermal constraint, the performance requirement, the latency requirement, and the current requirement.

In some embodiments, the first set of cores 210 and the second set of cores 220 are configured to use a shared resource 230 when executing processing operations. The shared resource 230, may be any resource including a fixed function processing block, a memory unit, such as a cache unit, or any other type of computing resource.

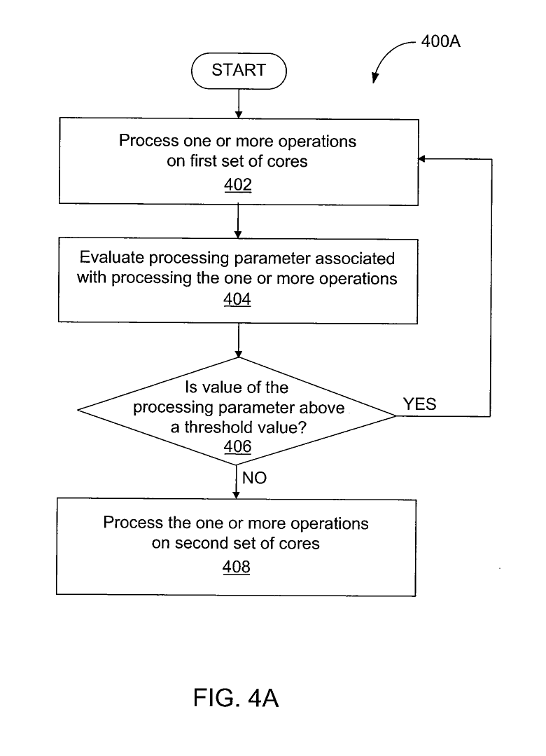

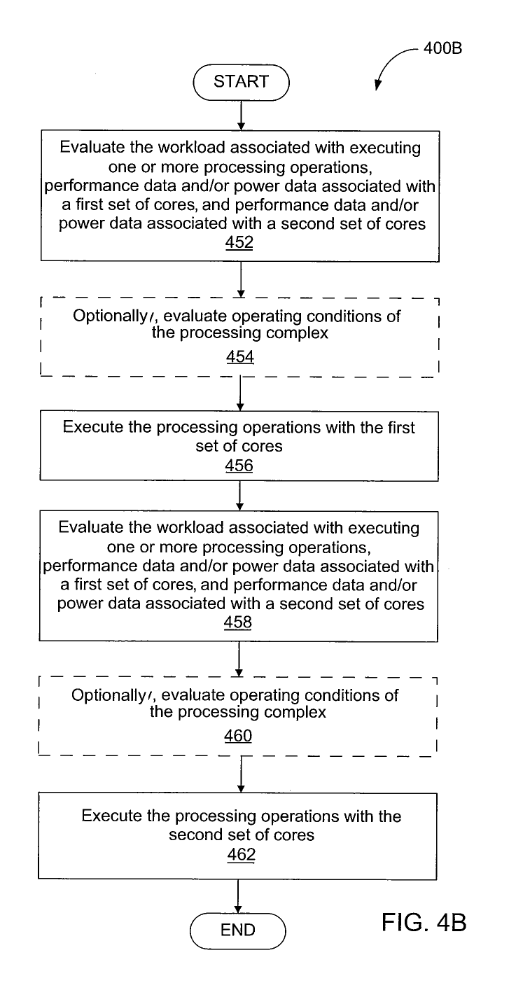

According to various embodiments, the process of analyzing the parameters and choosing the most appropriate set of cores to use is described in greater detail in FIGS. 4-6.

When execution of the processing operations switches from the first set of cores to the second set of cores, in some embodiments, the controller 240 is configured to transfer the processor state from the first set of cores to the second set of cores. In one embodiment, the controller saves the processor state to the shared resource 230, triggers a hardware mechanism that stops and powers off the first set of cores 210, and boots the second set of cores 220. The second set of cores 220 then restores the processor state from the shared resource 230 and continues operation at the lower speed associated with the second set of cores 220. In other embodiments, the processing state may be stored in any memory unit when transferring execution of the operations between the two sets of cores. In still further embodiments, the processing state may be directly transferred to the other set of cores via a dedicated bus, where the processing state is not stored in any memory unit with switching between the two sets of cores. The transition from the first mode to the second mode, and vice versa, can be done transparently to high level software, such as the operating system.

According to some embodiments, the shared resource 230 is an L2 cache RAM, and the first and second sets of cores 210, 220 share the same L2 cache RAM.

In one embodiment, each of the first set of cores 210 and the second set of cores 220 includes an L2 cache controller. The L2 cache may include a single set of tag and data RAM. The control signals and buses between the first and second sets of cores 210, 220 and the L2 cache are multiplexed so that either the first set of cores 210 or the second set of cores 220 can control the L2 cache. In some embodiments, only one of the first and second sets of cores 210, 220 can control the L2 cache at a particular time. Also, in some embodiments, the read data bus from the RAM goes to both the first and second sets of cores 210, 220 and is used by whichever set of cores is active at the time.

In a processing complex that implements a common L2 cache, both sets of cores can have the performance advantages associated with implementing an L2 cache, without the additional area required for separate L2 caches. Additionally, two separate L2 caches would add significant delay to the processor mode switch. For example, on a switch from operating in the first mode to operating in the second mode, the data in the first L2 cache associated with the first set of cores would need to be copied to the second L2 cache associated with the second set of cores, thereby causing inefficiencies. Then, the first L2 cache would need to be flushed or zeroed-out to remove old data, thereby causing additional inefficiencies. Another advantage of using a common L2 cache 230 is that when switching from operating in the first mode to operating in the second mode, the processor state can be saved and restored in the L2 cache 230, thereby speeding up the mode switch. In some embodiments, the processor state includes L1 cache contents included in L1 cache associated with each processor 210, 220.

As persons having ordinary skill in the art would understand, an L2 cache is just one example of a memory unit used to transfer data related to processing the one or more operations. In various embodiments, the memory unit comprises a non-cache memory or a cache memory. Also, in various embodiments, the data related to processing the one or more operations includes instructions, state information, and/or processed data. Also, in various embodiments, the memory unit may comprise any technically feasible memory unit, including an L2 cache memory, an L1 cache memory, an L1.5 cache memory, or an L3 cache memory. Also, as described above, in some embodiments, the shared resource 230 is not a memory unit, but can be any other type of computing resource.

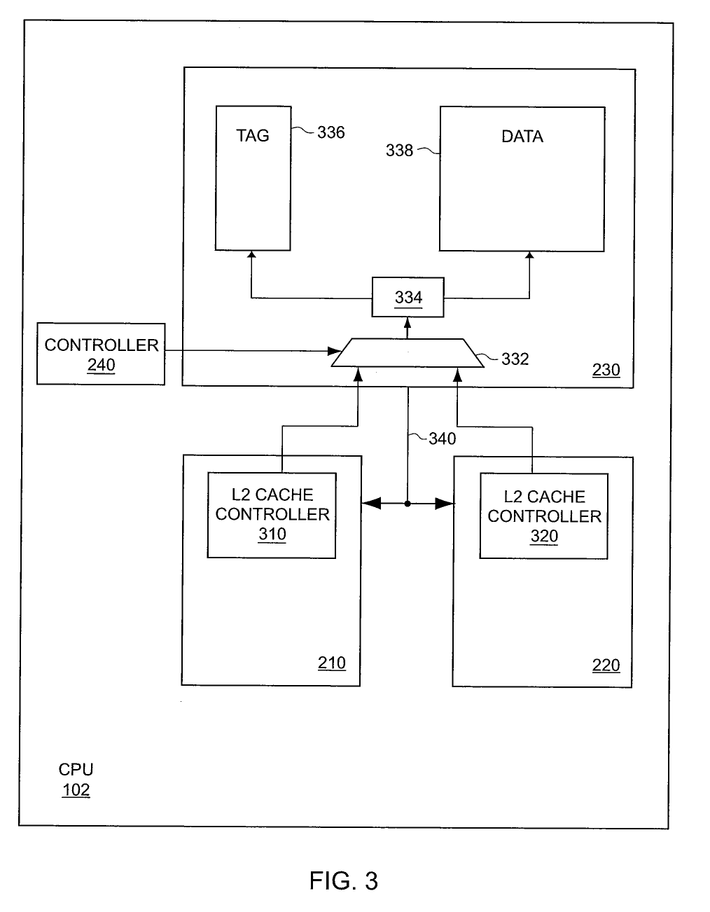

FIG. 3 is a conceptual diagram illustrating a processor 102 that includes a shared resource 230, such as L2 cache, according to one embodiment of the invention. As shown, the processing complex 102 includes a first set of cores 210, a second set of cores 220, a shared resource 230, and a controller 240, similar to those shown in FIG. 2.

The first set of cores 210 is associated with an L2 cache controller 310 and the second set of cores 220 is associated with an L2 cache controller 320. The L2 cache controllers 310, 320 may be implemented in software and executed by the first set of cores 210 and the second set of cores 220, respectively. In some embodiments, the L2 cache controllers 310, 320 are configured to interact with and/or or write data to the shared resource 230. In other embodiments, the first set of cores 210 and the second set of cores are configured to use a different shared resource, other than a memory unit.

In some embodiments, the L2 cache is used as an intermediary memory store for data associated with read/write commands being retrieved from or transmitted to another memory associated with the CPU 102, among other uses. As persons having ordinary skill in the art would understand, an L2 cache is just one example of a memory unit used to transfer data related to processing the one or more operations. In various embodiments, the memory unit comprises a non-cache memory or a cache memory. Also, in various embodiments, the data related to processing the one or more operations includes instructions, state information, and/or processed data. Also, in various embodiments, the memory unit may comprise any technically feasible memory unit, including an L2 cache memory, an L1 cache memory, an L1.5 cache memory, or an L3 cache memory. The L2 cache includes a multiplexor 332, a tag look-up unit 334, a tag store 336, and a data cache unit 338. Other elements included in the L2 cache, such as read and write buffers, are omitted to avoid obscuring embodiments of the invention.

In operation, the L2 cache receives read and write commands from the first and second sets of cores 210, 220. A read command buffer receives read commands from the first and second sets of cores 210, 220, and a write command buffer receives write commands from first and second sets of cores 210, 220. The read command buffer and write command buffer may be implemented as FIFO (first-in-first-out) buffers, where the commands received by the read command buffer and the write command buffer are output in the order the commands are received from the processors 210, 220.

As described herein, in some embodiments, only one of the first set of cores 210 or the second set of cores 220 is active and operating at a particular time. The controller 240 may be configured to transmit a signal to the multiplexor 332 within the L2 cache that allows either one of the sets of cores 210, 220 to access the shared resource 230 (e.g., the L2 cache).

According to some embodiments, read and write commands transmitted from the active set of cores to the L2 cache 230 are received by the tag look-up unit 334. Each read/write command received by the tag look-up unit 334 includes a memory address indicating the memory location at which the data associated with that read/write command is stored. The data associated with a write command is also transmitted to the write data buffer for storage. The tag look-up unit 334 determines memory space availability within the data cache unit 338 to store the data associated with the read/write commands received from the processors.

Persons skilled in the art will understand that any technically feasible technique for determining how the data associated with the read or write command is cached in and evicted from the cache unit is within the scope of embodiments of the invention. Also, in embodiments where the shared resource is not a memory unit, any technically feasible technique for utilizing the shared resource is within the scope of embodiments of the invention.

FIG. 4A is a flow diagram of method steps for switching between modes of operation of a processing complex, according to one embodiment of the invention. Although the method steps are described in conjunction with the systems of FIGS. 1-3, persons skilled in the art will understand that any system configured to perform the method steps, in any order, is within the scope of embodiments of the invention.

As shown, the method 400A begins at step 402, where a controller included in the processor causes one or more operations to be executed by a first set of cores. In one embodiment, when processing the one or more operations using the first set of cores, the cores included in the second set of cores are disabled and powered off. In alternative embodiments, when processing the one or more operations using the first set of cores, the cores included in the second set of cores are clock gated and/or power gated. At step 404, the controller evaluates a processing parameter associated with processing the one or more operations. For example, the processing parameter may be a processing frequency or an instruction throughput, as described above.

At step 406, the controller determines whether a value of the processing parameter is above a threshold value. In some embodiments, determining whether the value of the processing parameter is above the threshold value is determined dynamically at regular time intervals based on the current processing operations being executed by the processor. If the controller determines that the value of the processing parameter is above the threshold value, then the method 400A return to step 402, described above. If the controller determines that the value of the processing parameter is not above the threshold value, then the method 400A proceeds to step 408.

At step 408, the controller causes one or more operations to be executed by a second set of cores. In some embodiments, the one or more operations should be processed by the second set of cores when less power would be consumed by the processing complex if the one or more operations were processed by the second set of cores. In some embodiments, when processing the one or more operations switches from a first set of cores to a second set of cores, the same name number of cores continues the execution of the one or more operations. For example, if four cores included in the first set of cores are processing the one or more operations and a switch is made to the second set of cores, then four cores included in the second set of cores are used to process the one or more operations. In other embodiments, any number of cores may be used to process the one or more operations. In still further embodiments, the number of cores in the first set of cores that is processing the one or more operations is different number of cores in the second set of cores used to process the one or more operations after switching from the first set of cores to the second set of cores.

FIG. 4B is another flow diagram of method steps for switching between modes of operation of a processing complex, according to another embodiment of the invention. Although the method steps are described in conjunction with the systems of FIGS. 1-3, persons skilled in the art will understand that any system configured to perform the method steps, in any order, is within the scope of embodiments of the invention.

As shown, the method 400B begins at step 452, where a controller included in the processor evaluates the workload associated with processing operations, performance data and/or power data associated with the first set of cores, and performance data and/or power data associated with a second set of cores.

As described above, the performance data and/or power data associated with the first set of cores and the performance data and/or power data associated with the second set of cores may be stored within fuses associated with the processing complex. In alternative embodiments, the performance data and/or power data associated with the first set of cores and the performance data and/or power data associated with the second set of cores is determined dynamically during operation of the processing complex.

At step 454, the controller optionally evaluates operating conditions of the processing complex. As described above, the operating conditions may be determined dynamically during operation of the processing complex. The one or more operating conditions may include at least one of a supply voltage, a temperature of each chip included in the processing complex, and an average leakage current over a period of time of each chip included in the processing complex. In some embodiments, step 454 is optional and is omitted.

At step 456, the controller causes the processing operations to be executed by the first set of cores based on the workload associated with processing operations, the performance data and/or power data associated with the first set of cores, and the performance data and/or power data associated with a second set of cores. In one embodiment, the first set of cores comprises “fast” cores and the second set of cores comprises “slow” cores. As described herein, executing the processing operations by the first set of cores may achieve lower total power consumption than executing the processing operations by the second set of cores. In embodiments where the controller evaluates the operating conditions at step 454, the controller causes the processing operations to be executed by the first set of cores further based on the operating conditions.

At step 458, the controller, once again, evaluates the workload, the performance data and/or power data associated with the first set of cores, and the performance data and/or power data associated with a second set of cores. In some embodiments, step 458 is substantially similar to step 452 described above.

At step 460, the controller, once again, optionally evaluates operating conditions of the processing complex. In some embodiments, step 460 is substantially similar to step 454 described above. In some embodiments, step 460 is optional and is omitted.

At step 462, the controller causes the processing operations to be executed by the second set of cores based on the workload, the performance data and/or power data associated with the first set of cores, and the performance data and/or power data associated with a second set of cores. As described herein, executing the processing operations by the second set of cores may achieve lower total power consumption than executing the processing operations by the first set of cores.

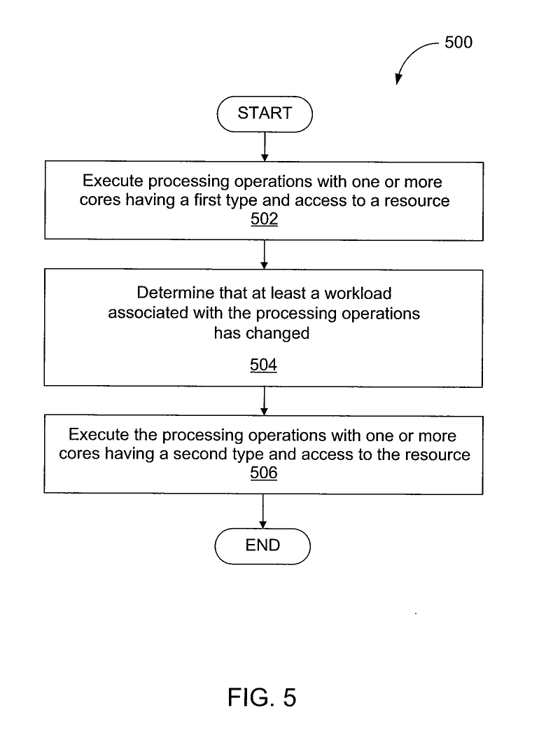

FIG. 5 is a flow diagram of method steps for switching between modes of operation of a processor having a shared resource, according to one embodiment of the invention. Although the method steps are described in conjunction with the systems of FIGS. 1-3, persons skilled in the art will understand that any system configured to perform the method steps, in any order, is within the scope of embodiments of the invention.

As shown, the method 500 begins at step 502, where the processor is executing processing operations with one or more cores having a first type and having access to a shared resource. According to various embodiments, the cores having the first type are characterized as “fast” cores associated with a particular silicon composition and process technology. In some embodiments, the cores having the first type that can achieve high performance, but are associated with a high leakage power component. In some embodiments, when the processor is executing processing operations with the one or more cores having a first type, the one or more cores having a first type can access a shared resource local to the one or more cores having the first type. In some embodiments, the shared resource is a memory unit. For example, the memory unit may comprise any technically feasible memory unit, including an L2 cache memory, an L1 cache memory, an L1.5 cache memory, or an L3 cache memory. In other embodiments, the shared resource may be any other type of computing resource. For example, the shared resource may be a floating point unit, or other type of unit.

At step 504, the controller determines that at least a workload associated with processing complex has changed, thereby determining that the processing operations should be executed by one or more cores having a second type. According to various embodiments, the cores having the second type are characterized as “slow” cores associated with a particular silicon composition and process technology. In some embodiments, the cores having the second type achieve lower performance, but are associated with a lower leakage power component. In some embodiments, based on at least the workload, executing the processing operations by the one or more cores having the second type may be associated with lower total power consumption. As described herein, in some embodiments, one or more factors may also contribute the determination of whether to switch processing from the first set of cores to the second set of cores, including the workload, the performance characteristics of the first and second sets of cores, the power characteristics of the first and second sets of cores, and/or the operating conditions of the processing complex.

At step 506, the processor executes the processing operations with the one or more cores having the second type and having access to the shared resource. As described, based one or more of the workload, the performance characteristics of the first and second sets of cores, the power characteristics of the first and second sets of cores, and/or the operating conditions of the processing complex, executing the processing operations by the one or more cores having the second type may be associated with lower total power consumption.

In some embodiments, on a switch from operating using the cores having the first type to the cores having the second type, the processor state of the cores having the first type may be stored in a memory unit by the controller associated with cores having the first type. Then, the cores having the second type may retrieve the processing state from the memory unit and restore the processing state when operating using the cores having the second type. In some embodiments, the memory unit through which the processor state is transferred to the second set of cores is the same unit as the shared resource. In other embodiments, the processor state is transferred to the second set of cores via a unit different than the shared resource. In still further embodiments, the processor state is transferred directly from the first set of cores to the second set of cores via a dedicated bus.

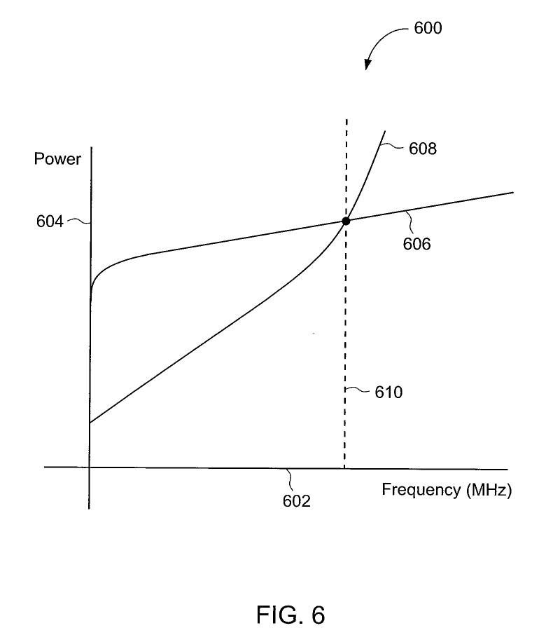

FIG. 6 is a conceptual diagram 600 illustrating power consumption as a function of operating frequency for different types of processing cores, according to one embodiment of the invention. As shown, operating frequency is shown on axis 602 and power consumption is shown on axis 604.

A first set of cores included in a processing complex may be associated with “fast” cores and a second set of cores in the processing complex may be associated with “slow” cores, as described herein. According to one embodiment, a graph of the power consumption associated with the fast cores as a function of operating frequency is shown by path 606, and a graph of the power consumption associated with the slow cores as a function of operating frequency is shown by path 608.

As shown, when operating the processing complex at lower frequencies, executing the processing operations with the slow cores is associated with lower total power consumption. In some embodiments, the lower total power associated with operating the processing complex at lower frequencies using the slow cores is based on the lower leakage power associated with the slow cores.

As operating frequency increases, the power associated with operating the processing complex increases, both for the fast cores and the slow cores. At a particular operating frequency threshold 610, executing the processing operations with the slow cores is associated with the same total power consumption as executing the processing operations with the fast cores. However, at operating frequencies higher than operating frequency threshold 610, executing the processing operations with the fast cores is associated with lower total power consumption.

In some embodiments, a controller included in the processing complex determines whether executing the processing operations with the fast cores or executing the processing operations with the slow cores achieves lower power consumption. In some embodiments, the determination of which type of cores to use when executing the processing operations may be based on operating frequency, as shown in FIG. 6. In other embodiments, a threshold value associated with any other operating condition associated with processing the workload may be used to determine whether to execute the processing operations using the fast cores or the slow cores.

In addition, in some embodiments, a controller may be configured to vary the voltage and/or operating frequency of the active cores before the number of active cores is increased or decreased. Any technically feasible technique, such a dynamic voltage and frequency scaling (DVFS), may be implemented to vary the voltage and/or operating frequency of the active cores. Again, according to various embodiments, vary the voltage and/or operating frequency of the active cores may cause the processor to operate at a lower total power consumption, thereby reducing the power required to executing the processing operations.

In sum, embodiments of the invention provide techniques for reducing the power consumption required to execute processing operations. One embodiment of invention provides a processing complex, such as a CPU or a GPU, which includes a first set of cores comprising one or more fast cores and second set of cores comprising one or more slow cores. Accordingly, a processing mode of the processing complex can switch between a first mode and a second mode based on one or more of the workload, performance characteristics of the first and second sets of cores, power characteristics of the first and second sets of cores, and/or operating conditions of the processing complex, where a controller can cause the processing operations to be executed by either the first set of cores or the second set of cores to achieve the lowest total power consumption. In addition, some embodiments of the invention allow the first set of cores and the second set of cores to share a resource, such as an L2 cache.

Advantageously, embodiments of the invention provide techniques to decrease the total power consumption associated with executing processing operations.

While the foregoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention. Therefore, the scope of the present invention is determined by the claims that follow.

What is claimed is:

1. A computer-implemented method for processing one or more operations within a processing complex, the method comprising:
causing the one or more operations to be processed by a first set of cores within the processing complex;
evaluating at least a workload associated with processing the one or more operations to determine that the one or more operations should be processed by a second set of cores included within the processing complex; and
causing the one or more operations to be processed by the second set of cores.

2. The method of claim 1, wherein the first set of cores includes N cores, and the second set of cores includes M cores, where N is not equal to M.

3. The method of claim 2, wherein the first set of cores includes four cores, and the second set of cores includes one core.

4. The method of claim 1, wherein the one or more operations should be processed by the second set of cores when less power would be consumed by the processing complex if the one or more operations were processed by the second set of cores.

5. The method of claim 1, wherein the step of evaluating at least the workload comprises determining whether a processing parameter associated with processing the one or more operations is greater than or less than a threshold value.

6. The method of claim 5, wherein the processing parameter comprises processing frequency, and the step of evaluating at least the workload comprises determining that the one or more operations should be processed at a processing frequency that is greater than or less than a threshold frequency.

7. The method of claim 6, wherein the step of evaluating at least the workload comprises determining that the one or more operations should be processed at a frequency less than the threshold frequency.

8. The method of claim 7, wherein the first set of cores comprises transistors that operate at higher frequencies and have greater static power leakage relative to transistors that comprise the second set of cores.

9. The method of claim 5, wherein the processing parameter comprises instruction throughput, and the step of evaluating at least the workload comprises determining that the instruction throughput when processing the workload should be greater than or less than a threshold throughput.

10. The method of claim 9, wherein the step of evaluating at least the workload comprises determining that the instruction throughput when processing the workload should be less than the threshold throughput.

11. The method of claim 1, wherein the first set of cores is disabled and powered off when the one or more operations are processed by the second set of cores.

12. The method of claim 1, wherein the first set of cores is clock gated and/or power gated when the one or more operations are processed by the second set of cores.

13. A computer-readable medium including instructions that, when executed, cause a processing complex to perform the steps of:
causing one or more operations to be processed by a first set of cores included within the processing complex;
evaluating at least a workload associated with processing the one or more operations to determine that the one or more operations should be processed by a second set of cores included within the processing complex; and
causing the one or more operations to be processed by the second set of cores.

14. The computer-readable medium of claim 13, wherein the first set of cores includes N cores, and the second set of cores includes M cores, where N is not equal to M.

15. The computer-readable medium of claim 13, wherein the one or more operations should be processed by the second set of cores when less power would be consumed by the processing complex if the one or more operations were processed by the second set of cores.

16. The computer-readable medium of claim 13, wherein the step of evaluating at least the workload comprises determining whether a processing parameter associated with processing the workload is greater than or less than a threshold value.

17. The computer-readable medium of claim 16, wherein the processing parameter comprises processing frequency or instruction throughput.

18. A computing device, comprising:
a processor configured to:
cause one or more operations to be processed by a first set of cores,
evaluate at least a workload associated with processing the one or more operations to determine that the one or more operations should be processed by a second set of cores, and
cause the one or more operations to be processed by the second set of cores.

19. The computing device of claim 18, further comprising a memory that includes instructions that, when executed, cause the processor to cause the one or more operations to be processed by the first set of cores, evaluate the at least the workload, and cause the one or more operations to be processed by the second set of cores.

20. The computing device of claim 18, wherein the first set of cores includes N cores, and the second set of cores includes M cores, where N is not equal to M.

21. The computing device of claim 20, wherein the first set of cores includes four cores, and the second set of cores includes one core.

22. The computing device of claim 18, wherein the first set of cores comprises transistors that operate at higher frequencies and have greater static power leakage relative to transistors that comprise the second set of cores.
